(19) United States
(12) Patent Application Publication
(10) Pub. No.: US 2026/0034547 A1
(43) Pub. Date: Feb. 5, 2026

(54) REAGENT DISPENSING APPARATUS WITH DROP DETECTION AND VERIFICATION

(71) Applicant: HIGHRES BIOSOLUTIONS, INC., Beverly, MA (US)

(72) Inventors: Brian L. Ganz, Carlsbad, CA (US); Nicholas Pratte, Carlsbad, CA (US); Benjamin M. Liedblad, Carlsbad, CA (US)

(21) Appl. No.: 18/429,201

(22) Filed: Jan. 31, 2024

(51) Int. Cl. B01L 3/00

(52) U.S. Cl. CPC B01L 3/52; B01L 2200/16; B01L 2300/0663; B01L 2400/0622

(57) ABSTRACT

A reagent dispensing apparatus. A dispensing module is attached to a support frame and includes a pressurized fluid delivery system. The fluid delivery system includes a reagent container, a dispensing head connected to the reagent container, a dispensing valve connected to the dispensing head, and a dispensing tip connected to the dispensing head. The reagent dispensing system also includes a motion drive system. A sensor remains focused on the area immediately underneath the dispensing tip. A computer is programmed to receive inputs from said sensor to determine drop success or failure from the dispensing tip. The computer is programmed to control the motion drive system to position a plate under the dispensing tip, and the computer is also programmed to open and close the dispensing valve to permit and stop fluid from flowing to the dispensing tip.

The present invention relates to reagent dispensing devices, and in particular high-capacity reagent dispensing devices.

### BACKGROUND OF THE INVENTION

Reagent dispensers are known in the prior art. An exemplary reagent dispenser is disclosed in great detail in U.S. Patent Publication No. 2005/0032241, all of which is incorporated by reference herein.

FIG. 1 show prior art dispensing apparatus 5. The dispensing apparatus 5 includes a support frame 15 and a detachable reagent dispensing module 10. The support frame 15 provides a stable base support for the dispensing module 10 and associated accessories. Furthermore, the support frame 15 may be adapted to house other associated equipment, such as: a motor drive system 65 which moves the microplate 60; a computer 110 having software programmed to control motor drive system 65 which in turn generates encoder counts used to control dispensing devices 45 (FIG. 3A); a pressurized air source 115 to pressurize the fluid delivery subsystem 20 (FIG. 2); and any required electrical connections and power supply sources.

The dispensing module 10 (shown in more detail in FIG. 2) is removably attached to the support frame 15. The dispensing module 10 comprises a self-contained pressurized fluid delivery subsystem 20. The dispensing module 10 is adapted for complete and reproducible attachment to or detachment from the support frame 15, thus avoiding cumbersome manipulation of reagent containers 25 and/or fluid paths between uses.

FIGS. 3A and 3B show a multi-tip dispensing array 40 with discrete corresponding fluid paths associated with each corresponding dispensing tip 35. Dispensing head 140 is shown in detail. Dispensing head 140 contains the terminal portions of the fluid paths, and is attached to the platform 180 of the dispensing module 10 by use of bolts, screws, or other suitable means. For example, boreholes 280 may be adapted to receive bolts from the underside of dispensing head 140. Proper alignment of dispensing head 140 may be accomplished by utilizing alignment pins 275 designed to mate with corresponding indents or holes (not shown) on platform 180. Alternatively, dispensing head 140 and dispensing module 10 may be formed as an integrated component.

Dispensing head 140 includes a support block 165 that provides a platform for supporting discrete fluid tubes 145, which are further secured to support block 165 by brackets 285. Each discrete fluid tube 145 is fluidly connected to a corresponding discrete dispensing device 45 for controlling selective dispensing of a corresponding reagent 50 through a corresponding dispensing tip 35. Typically, each dispensing device 45 includes corresponding electrical lead(s) 150 for receiving signals that control the opening and closing of a valve contained therein, an adaptor 155 for receiving a corresponding fluid delivery line 160, and a corresponding section of fluid tube 145. Tip array 40 may be further guided and supported for precision accuracy by a ring 290 used to clamp tip array 40 to a support rod 270. Support rod 270 has grooves 273 for receiving tip array Ring 290 may be soldered, brazed, laser welded or glued around tip array 40.

Acting as a supporting platform, the support block 165 may be constructed of any suitable material capable of providing stability to the dispensing devices 45, rectangular tip array 40, and associated hardware for securely receiving the aforementioned. Additional stability and protection of the fluid tubes 145, from bending or other inappropriate contact, may be achieved by using protective sleeves 170. Ideally, the protective sleeves 170 are associated with a section of the fluid tubes 145 located between the dispensing devices 45 and the dispensing tips 35. Protective sleeves 170 may be PVC tubing, rubber, Tygon®, or other suitable material.

Discrete adaptors 155 fluidly connect corresponding fluid delivery lines 160 to corresponding dispensing devices 45. The dispensing devices 45 may be solenoid valves or piezoelectric dispensers, for example. The dispensing devices 45 selectively control reagent dispensing. Solenoid valve dispensers, of the type used in one embodiment of the present invention, are commonly used for ink-jet printing. Electrical and mechanical operation of a solenoid valve dispenser is well known in the art. Briefly, the dispenser generally comprises a solenoid portion, a valve portion, and electrical leads 150. The solenoid portion comprises an electromagnetic coil, a static core, and a movable plunger. The static core and movable plunger are disposed within a hollow cylindrical sleeve (fluid tube 145) to allow passage of a reagent. The static core and movable plunger are preferably formed of a ferrous or magnetic material. When the solenoid coil is energized through electrical leads 150, as described herein, via electrical signals controlled by a computer program, a magnetic field is created which draws the plunger toward the static core and away from a valve portion allowing pressurized reagent to be dispensed past the valve opening. Reagent then exits the solenoid valve openings into a section of the fluid tube 145 that terminates at a dispensing tip 35 where reagent 50 is dispensed into target wells in a microwell plate.

A serious problem with reagent dispensers, such as the prior art dispensing device 5 described above, is improper or failed dispensing of drops. For example, a drop may be dispensed incorrectly or not at all. A user currently may not realize or have confidence that all drops have been properly dispensed. A hanging drop may occur or a clogged or defective valve can cause a dispensing error. The dispensing process is performed very quickly and using prior art methods it is very difficult to know if drops have been properly dispensed.

What is needed is a device and method for accurately determining if a reagent dispenser has properly dispensed drops.

### SUMMARY OF THE INVENTION

The present invention provides a reagent dispensing apparatus. A dispensing module is attached to a support frame and includes a pressurized fluid delivery system. The fluid delivery system includes a reagent container, a dispensing head connected to the reagent container, a dispensing valve connected to the dispensing head, and a dispensing tip connected to the dispensing head. The reagent dispensing system also includes a motion drive system. A sensor remains focused on the area immediately underneath the dispensing tip. A computer is programmed to receive inputs from said sensor to determine drop success or failure from the dispensing tip. The computer is programmed to control the motion drive system to position a plate under the dispensing tip, and the computer is also programmed to open and close the dispensing valve to permit and stop fluid from flowing to the dispensing tip.

### BRIEF DESCRIPTION OF THE DRAWINGS

FIGS. 1-3B show a prior art dispensing apparatus.

FIG. 4 shows a preferred embodiment of the present invention. FIGS. 5-7 show functionalities of a preferred sensor.

FIG. 8 shows a prior art dispensing head.

FIG. 9 shows connectivity of a preferred embodiment of the present invention.

FIGS. 10a-10b show a flowchart describing the operation of a preferred embodiment of the present invention.

FIGS. 11a-11b show a flowchart describing the operation of another preferred embodiment of the present invention.

### DETAILED DESCRIPTION OF THE PREFERRED EMBODIMENTS

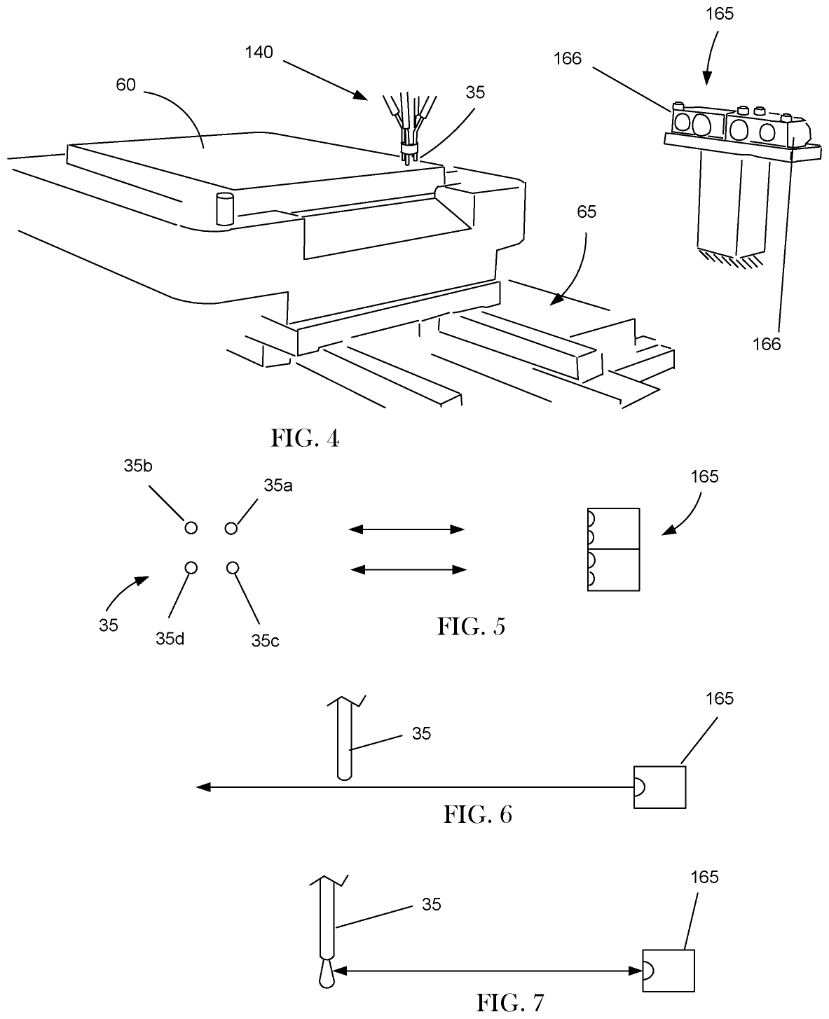

The present invention utilizes a drop detection sensor to determine if a drop has properly been dispensed from dispensing tips 35 of dispensing head 140. Drop detection sensor 165 is always positioned to focus right below dispensing tips 35 (FIG. 4). In a preferred embodiment, drop detection sensor 165 includes two laser emitter/detector devices 166. A preferred laser emitter/detector device is the laser sensor head (part no LV-NH32) and the laser amplifier unit (part no. LV-N1 1N), both manufactured by the Keyence Corporation of America with offices in Itasca, Illinois. FIG. 5 shows sensor 165 arranged so that one of the laser emitter/detector devices is positioned to monitor tips 35a and 35b. The other laser emitter/detector device is positioned to monitor tips 35c and 35d.

FIG. 6 shows that the laser beam emitted by sensor is positioned to monitor the space immediately below tip 35. In FIG. 6, there is no drop so the beam is not reflected and the sensor does not sense a drop.

In FIG. 7, a drop is leaving tip 35. The laser beam from sensor 165 is reflected back to sensor 165 and is recorded as a drop.

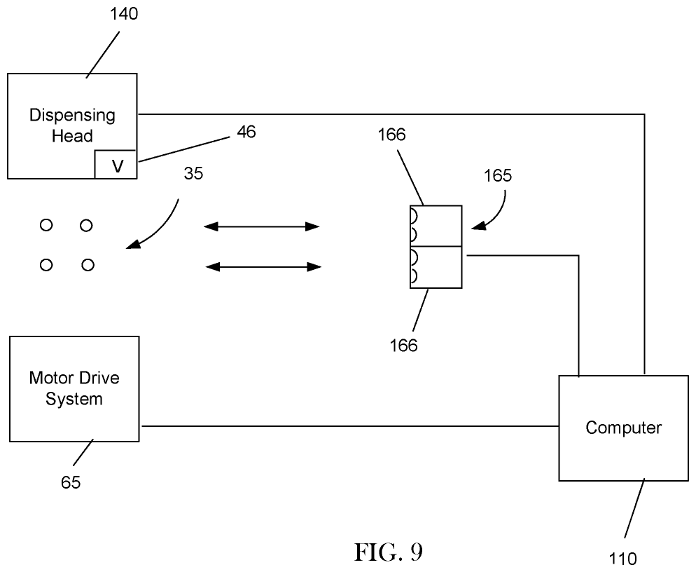

In a preferred embodiment of the present invention, computer 110 is programmed to control the motion of dispensing head 140, motor drive system 65 and the opening and closing of valves 46. Computer 110 receives inputs from sensor 165 relating to drops from dispensing tips 35 (FIG. 9).

### Timed Hanging Drop Detection with Valve Leak Detection

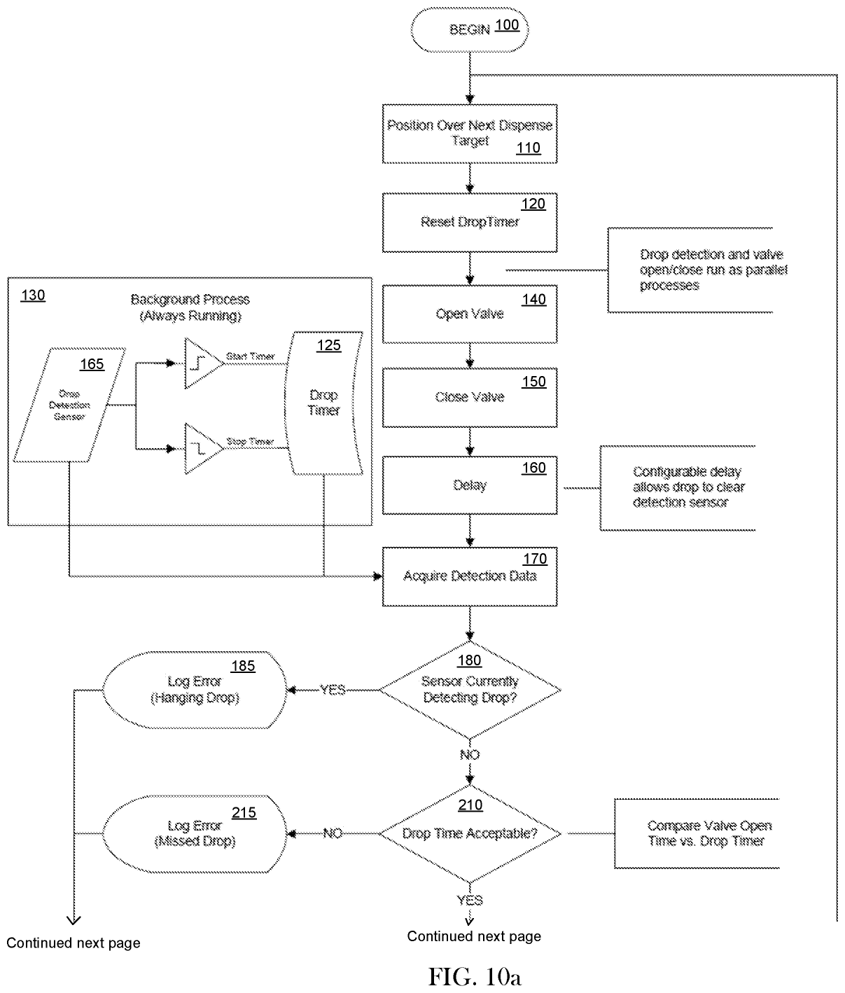

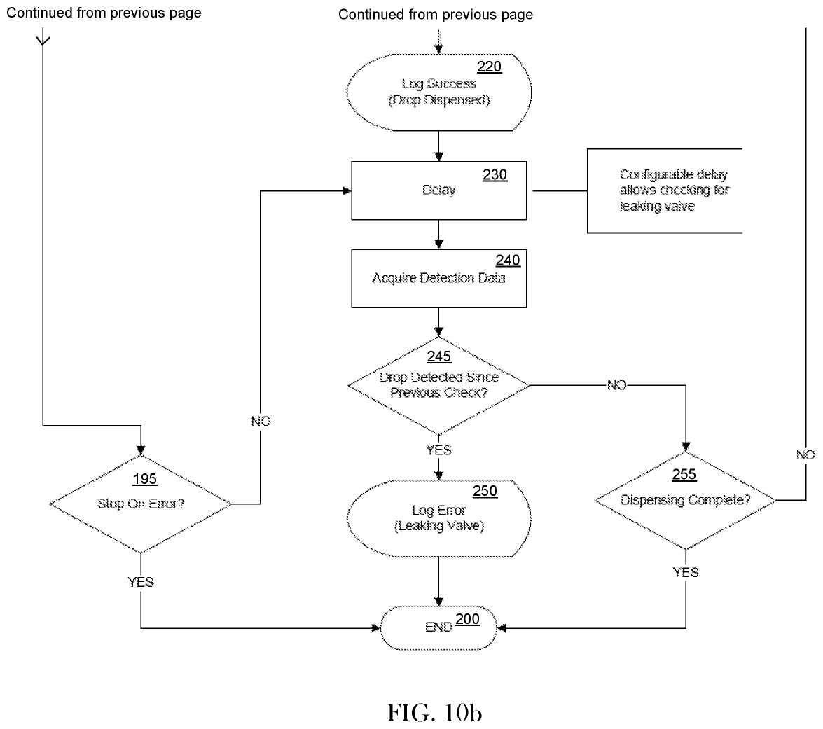

FIGS. 10-10a depict a flow chart showing the steps for a preferred method of hanging drop detection and valve leak detection. The method described is controlled by computer 110 appropriately programmed.

In step 100 the method has begun.

In step 110 motor drive system 65 maneuvers microwell plate 60 so that it positioned under dispensing head 140.

In step 120 drop timer 125 is reset. It should be noted that the drop detection and valve open and close function (step 130) are always running in the background as parallel processes.

In step 140, dispensing valve 46 has been opened allowing a drop to flow to one or more dispensing tips 35.

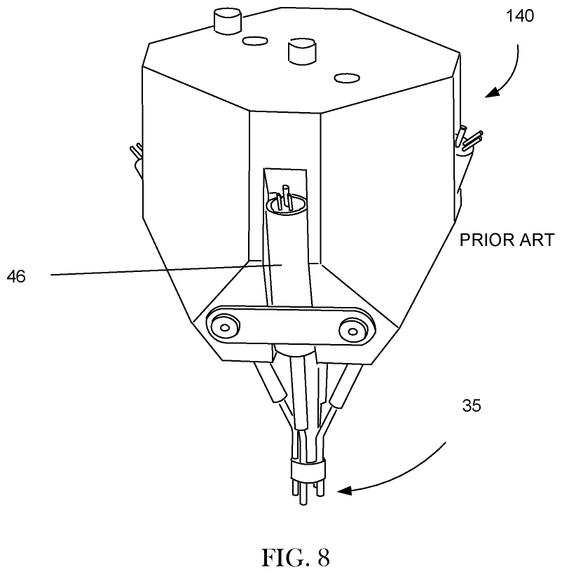

In step 150, dispensing valve 46 (FIG. 8) is closed.

In step 160 a delay is applied to allow the drop emitted from dispensing tip 35 to clear detection sensor 165.

In step 170, drop detection data is acquired.

In step 180 computer 110 is programmed to check the data to determine if drop detection sensor 165 is currently detecting a drop after allowing for the delay (step 160).

If a drop is being detected on step 180, then computer 110 determines a “log error” for a hanging drop (step 185). In a preferred embodiment, if the user has programmed computer 110 to stop on a log error for a hanging drop or missed drop (step 195) then the drop dispensing process stops (step 200).

If computer 110 is not programmed to stop on error (step 195) a delay will be applied to allow for checking of a leaky valve (step 230).

If a drop is not detected on step 180, then computer 110 is programmed to check to see if the drop time was acceptable (step 210). To determine if the drop time is acceptable computer 110 is programmed to compare the valve open time against the drop timer. If the drop time is acceptable, then the computer determines a “log success” to verify that a drop was dispensed (step 220). If on step 210, the computer determines that the drop time was not acceptable, the computer 110 is programmed to determine a “log error” for a missed drop (step 215). In a preferred embodiment, if the user has programmed computer 110 to stop on a log error for a hanging drop or missed drop (step 195) then the drop dispensing process stops (step 200).

If computer 110 determines the drop time is acceptable (step 210), a “log success” for a drop dispensed (step 220) will be determined.

After which, in step 230 a delay is applied to allow for the checking of a leaky valve 46. In step 240, drop detection data is acquired.

In step 245, the computer checks to see if a drop was detected since the previous check. If a drop is detected an error is logged for a leaky valve (step 250). The dispensing process then stops (step 200). If after step 245 the computer does not detect a drop since the previous check, then the computer checks to see if dispensing is complete (step 255). If dispensing is complete then the dispensing process is stopped (step 200). If the dispensing process is not complete then motor drive system 65 maneuvers microwell plate 60 so that the next well is properly positioned under dispensing head 140.

### Latched Hanging Drop Detection With Valve Leak Detection

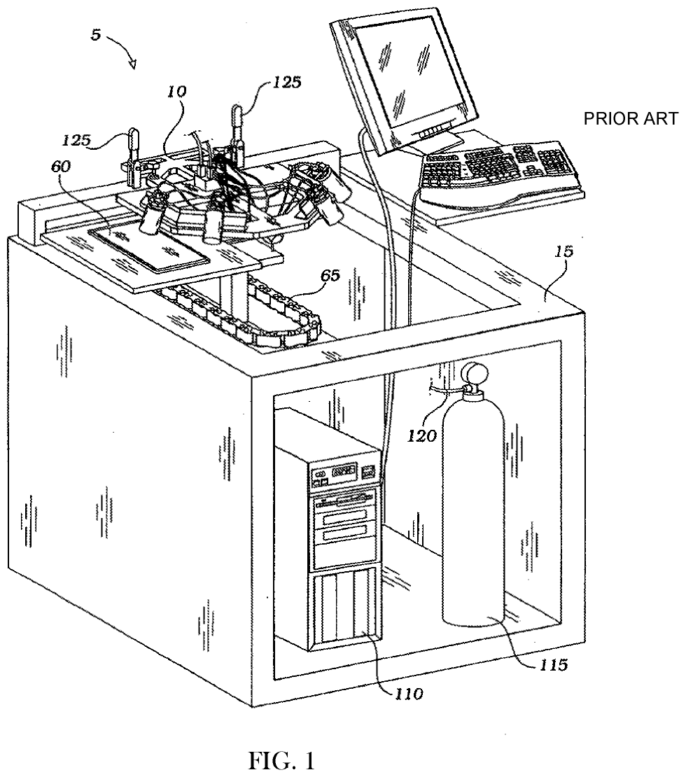

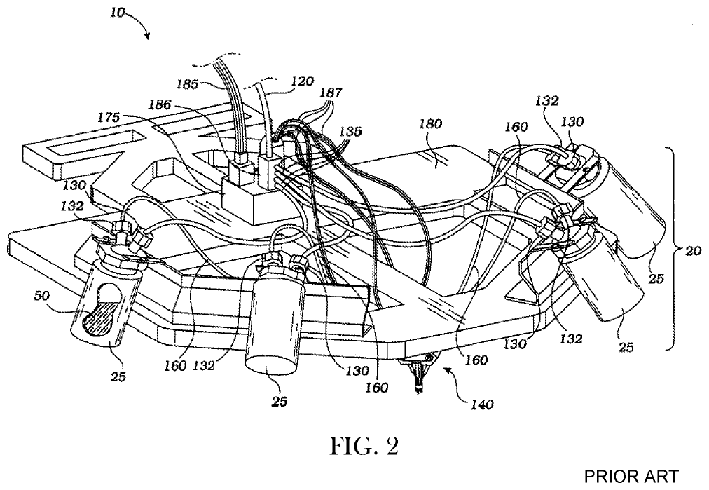

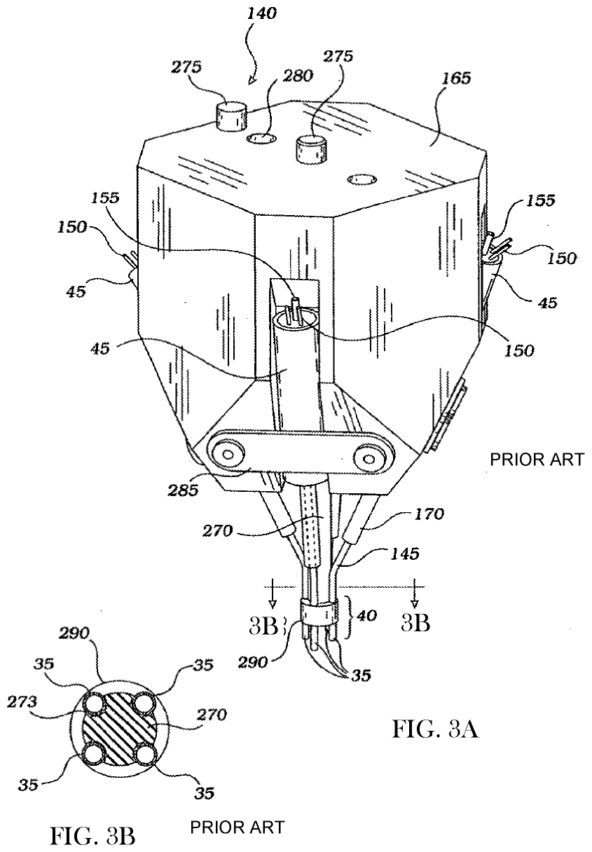

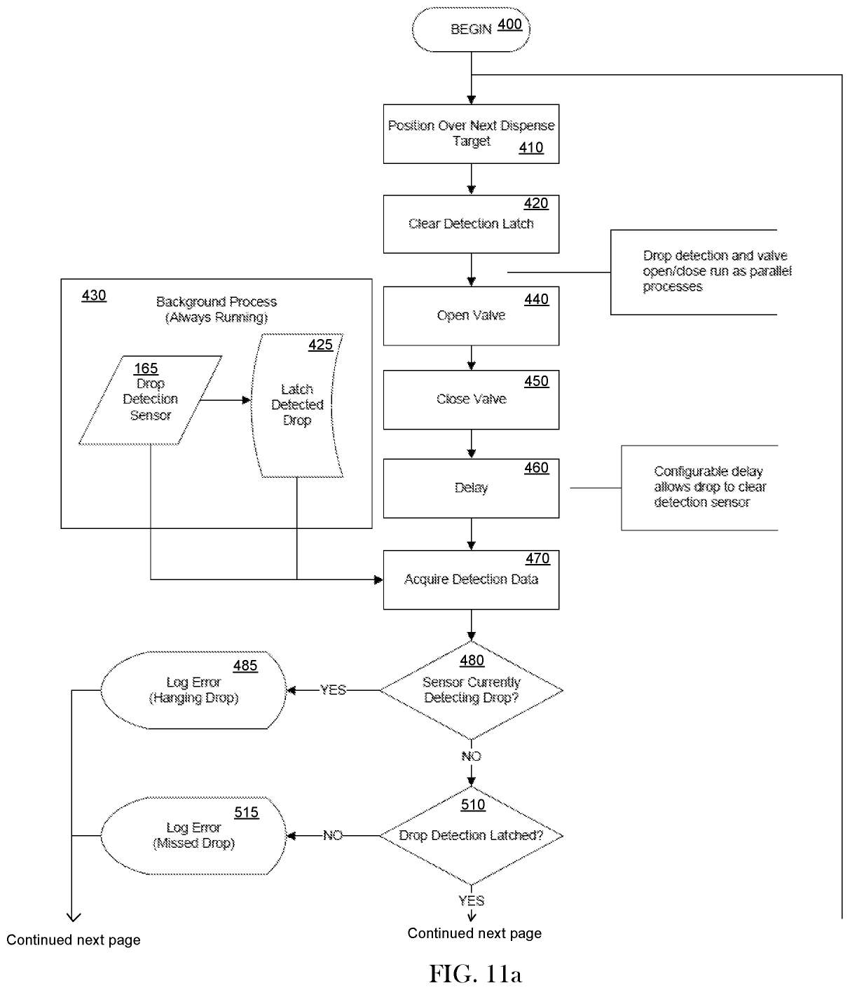

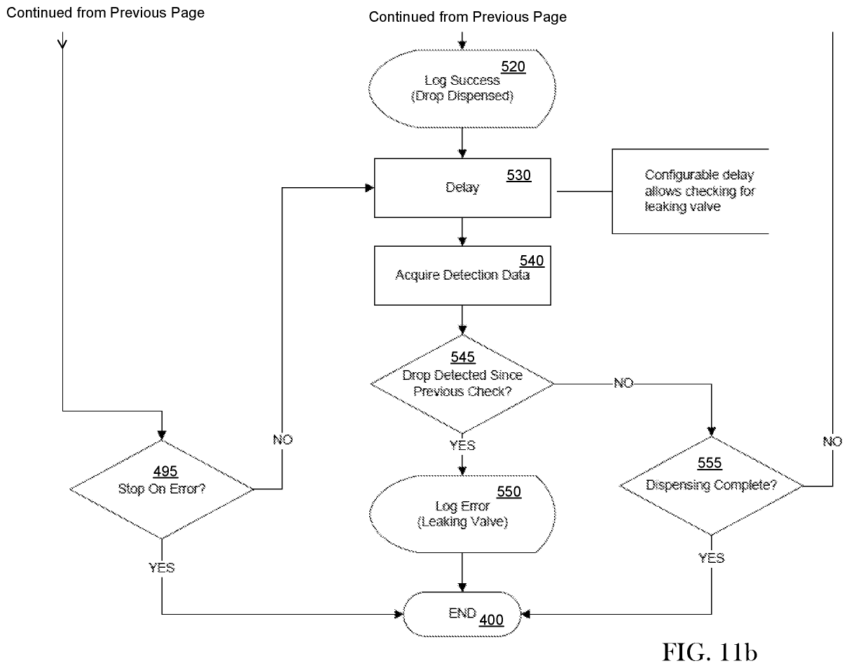

FIGS. 11-1la depict a flow chart showing the steps for another preferred method of hanging drop detection and valve leak detection. The method shown in FIG. B utilizes programmed latch detection of the drop. This method is appropriate when the drop is very small and the dispense time is very fast (approaching 0 seconds). The method described is controlled by computer 110 appropriately programmed.

In step 400 the method has begun.

In step 410 motor drive system 65 maneuvers microwell plate 60 so that it positioned under dispensing head 140.

In step 420 clear detection latch 425 is set. It should be noted that the drop detection and valve open and close function (step 430) are always running in the background as parallel processes.

In step 440, dispensing valve 46 has been opened allowing a drop to flow to one or more dispensing tips 35.

In step 450, dispensing valve 46 (FIG. 8) is closed.

In step 460 a delay is applied to allow the drop emitted from dispensing tip 35 to clear detection sensor 165.

In step 470, drop detection data is acquired.

In step 480 computer 110 is programmed to check the data to determine if drop detection sensor 165 is currently detecting a drop after allowing for the delay (step 460).

If a drop is being detected on step 480, then computer 110 determines a “log error” for a hanging drop (step 485). In a preferred embodiment, if the user has programmed computer 110 to stop on a log error for a hanging drop or missed drop (step 495) then the drop dispensing process stops (step 400).

If a drop is not detected on step 480, then computer 110 is programmed to check to see if the drop was detected via latch (step 510). If drop detection latch occurs, then the computer determines a “log success” to verify that a drop was dispensed (step 520). If on step 510, the computer determines that drop detection latch did not occur, then computer 110 is programmed to determine a “log error” for a missed drop (step 515). In a preferred embodiment, if the user has programmed computer 110 to stop on a log error for a hanging drop or missed drop (step 495) then the drop dispensing process stops (step 400).

If computer 110 determines drop detection latched (step 510), a “log success” for a drop dispensed (step 520) will be determined.

After which, in step 530 a delay is applied to allow for the checking of a leaky valve 46. In step 540, drop detection data is acquired.

In step 545, the computer checks to see if a drop was detected since the previous check. If a drop is detected an error is logged for a leaky valve (step 550). The dispensing process then stops (step 400). If after step 545 the computer does not detect a drop since the previous check, then the computer checks to see if dispensing is complete (step 555). If dispensing is complete then the dispensing process is stopped (step 400). If the dispensing process is not complete then motor drive system 65 maneuvers microwell plate 60 so that the next well is properly positioned under dispensing head 140 (step 410).

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

1. A reagent dispensing apparatus comprising:
A. a support frame,
B. a dispensing module removably attached to the support frame and comprising a self-contained pressurized fluid delivery subsystem, said fluid delivery system comprising:
a. at least one reagent container,
b. a dispensing head fluidly connected to said at least one reagent container,
c. a dispensing valve connected to said dispensing head,
d. at least one dispensing tip connected to said dispensing head,
C. a motion drive system,
D. a sensor focused on an area below said at least one dispensing tip,
E. a computer programmed to receive inputs from said sensor to determine drop success or failure from said at least one dispense tip, said computer programmed to control said motion drive system to position a plate under said at least one dispense tip, and said computer to open and close said dispensing valve.

2. The reagent dispensing apparatus as in claim 1, wherein said sensor is a laser emitter/detector.

3. The reagent dispensing apparatus as in claim 2, wherein said sensor is two laser emitter/detectors.

4. The reagent dispensing apparatus as in claim 1, wherein said at least one dispensing tip is a plurality of dispensing tips.

5. The reagent dispensing apparatus as in claim 4, wherein said plurality of dispensing tips are arranged in a square configuration.

6. The reagent dispensing apparatus as in claim 1, wherein said computer is programmed to alert of a hanging drop.

7. The reagent dispensing apparatus as in claim 1, wherein said computer is programmed to alert of a leaky valve.

8. The reagent dispensing apparatus as in claim 1, wherein said computer is programmed to utilize timed hanging drop detection with valve leak detection.

9. The reagent dispensing apparatus as in claim 1, wherein said computer is programmed to utilize latched hanging drop detection with valve leak detection.
